(19) United States
(12) Patent Application Publication
(10) Pub. No.: US 2021/0197167 A1
(43) Pub. Date: Jul. 1, 2021

(54) Extracting desired organic compounds from plants with controlled microwave energy

(71) Applicant: DESIRED ORGANIC MICROWAVE EXTRACTION, INC., Banning, CA (US)

(72) Inventors: Stanley Jay Hartz, Westminister, CO (US); Edwin Lincoln Hartz, Banniing, CA (US)

(73) Assignee: DESIRED ORGANIC MICROWAVE EXTRACTION, INC., Banning, CA (US)

(21) Appl. No.: 16/974,312

(22) Filed: Dec. 22, 2020

Related U.S. Application Data
(60) Provisional application No. 63/204,015, filed on Sep. 8, 2020.
(60) Provisional application No. 63/102,719, filed on Jun. 26, 2020.
(60) Provisional application No. 62/974,818, filed on Dec. 26, 2019.

(51) Int. Cl. B01J 19/12

(52) U.S. Cl. CPC B01J 19/126; B01J 2219/00033

(57) ABSTRACT

Method and system for Improved quality of selected organic compounds extracted from plant material, which may be the whole plant, a selected portion thereof, or combined parts of the plant, by use of one or more adjustable microwave sources in a closed loop from output to input. The selected portions may be the seeds, pods, leaves, stalks or a combination of one or more of the parts.

### CROSS REFERENCE TO RELATED APPLICATION

This application claims priority to Provisional Applications: U.S. Application No. 62/974,818 filed Dec. 26, 2019, U.S. Application No. 63/102,719 filed Jun. _, 2020 and U.S. Application No. 63/204,015 filed Sep. 9, 2020.

### FIELD OF THE INVENTION

Improved quality of selected organic compounds extracted from plant material, which may be the whole plant, a selected portion thereof, or combined parts of the plant, by use of one or more adjustable microwave sources in a closed loop from output to input. The selected portions may be the seeds, pods, leaves, stalks or a combination of one or more of the parts.

### BACKGROUND OF THE INVENTION

There are specific organic compounds of interest in selected plants. Non-limitng examples of such compounds of interest are: essential oils, eg. peppermint; consummable juices, eg. ginger juice and lemon juice; and cannabinoids, including CBDs, terpenes and CBGs. These organic compounds are held in place by the fibers of the plant and have been extracted by different methods and apparatus. Two methods of extraction are the use of a solvent to extract the desired compound and the the use of supercritical fluids to extract the compounds. Another method used to extract ginger juice utilizes heavy equipment in which the ginger root is cut into smaller pieces and then crushed under high pressure. Typically, for these methods, the plants are dried and milled into small pieces.

It has been reported that many of the organic compounds are damaged upon extraction from the plant material by the present methods. The damage may be a change caused by excessive heat or solvent residue mixed with the extracted organic compound. The use of a supercritical fluid or fluids may overheat the organic compound being extracted which results in a change in the chemical structure of some of the compounds.

### SUMMARY OF THE INVENTION

The system and process of this invention provides the ability to extract individual organic compounds from plant material by monitoring the spectral lines of the compounds at the output. A closed feedback loop responsive to the output of the monitoring device[s] controls the energy level of the input microwaves needed to extract the desired separate compounds. This method provides a selected compound with more purity and quality.

The plant material of interest may be represented by, but not limited to, hemp. Hemp, as well as other plants of interest, has a strong cellular body made up of long molecular chains. These long chains form the strong fibrous body which carries the desired organic compounds. The cellular body has a phase change from a solid at a temperature above 300° C. Consequently, the desired organic compounds may be extracted at lower temperatures without including the fibrous body. The phase change of the desired organic compounds for extraction is below 300° C. The energy for extraction is started at a low level and increased slowly to reach the energy level that causes the phase change of the selected compound.

To extract the desired organic compounds carried by the cellular body, the cellular fibers have to be broken apart to release the compounds. The body is broken apart in accordance with a preferred way by utilizing a microwave source providing pulsed energy with sufficiently high energy pulses applied to the water external to the plant material and in the plant material. This is to excite the water molecules around the skin of the plant which act like a water hammer to physically crack open the fibrous body. At the same time the water molecules inside the plant material are heated and change phase to help force open the plant material. If necessary, water is added around and on the plant material being processed to sustain the water hammer. The high energy pulse is of short duration to avoid heat damage that may cause chemical change to the desired organic compounds. After, during or intermittently with the water hammer, controlled continuous microwave energy is applied to the plant material. Controlling the energy level is especially important with the CBG compound. The CBG compound is a precursor of CBDs and will change into CBD and possibly other compounds, if too much heat is used in the process.

Once the body is broken open the compounds in a gas state will escape. These gaseous compounds, which include terpenes, are captured. Also, with the body open, the controlled continuous wave energy level from the microwave source causes the selected compound within the body to have a phase change from solid to liquid and/or gas for extraction.

The first selected compound, such as the CBG compound, is first extracted by application of sufficient energy to cause a phase change of the compound to permit extraction. Thereafter application of energy at a higher level causes a phase change of the next selected compound, such as CBDs, to permit extraction. No drying has been done. The water on and around the plant and/or trapped inside the material is used in the process.

By using a spectral output of choice to feed a process controller, the energy applied to the plant by an antenna is adjusted to maximize compound output while minimizing heat damage. The process makes the production of selected compounds more reliable and controllable. This method initially extracts the compounds which have a phase change for extraction at relatively low energy levels. To know that the right energy level has been reached, the spectral signature for the desired compound appears at the output. A spectrometer monitors the collected gas samples, and the same or different spectrometer monitors the collected liquid samples. When the spectral line for a selected compound is detected in the samples monitored by a spectrometer the energy level is held with minor adjustments if required. When the spectral line indicates that the compound is no longer being extracted the collection of this compound is ended. This process is continued for selected compounds which have a phase change at higher energy levels.

If the energy level for the phase change of the desired compound is too close to the level for the phase change of other compounds, plural compounds may be extracted and later separated in a distillation process. The compounds are essentially in their natural state upon extraction. The process makes the extraction of selected compounds more reliable and controllable.

The system may also be used for determining the quality of extracted compounds on the market or in a production facility. The system may also be used to quantify the properties of the plant material to be processed. This information is useful in setting up the process.

The System/Apparatus of this Invention consists of:
A. A process chamber that is microwave safe and having an internal work area large enough for a processing container and its necessary environmental inputs and outputs.
B. A processing container having outputs for gases and liquids and an input for adding water with or without other liquids to the interior of the container. The container is designed to hold pressure below the pressure which could damage the sensing and output devices.
C. A microwave energy source with an adjustable output. The source being solid-state and having modules. One or more modules provide controlled pulsed microwave energy in the range of 2.4 to 2.50 GHz and one or more modules provide adjustable continuous microwave energy in the range of 2.4 to 2.45 GHZ. One energy source may provide both functions or each function may be provided by separate sources.
D. Antennas or applicators directed at the plant material to deliver energy from the energy modules.
E. A controller for the energy source determines when to apply pulses from the energy source and when to apply continuous waves from the energy source by use of outside control commands (via LAN and U3B interfaces).
F. Spectrometers at the output of the container/chamber monitor the spectra of the extracted gases and/or liquids to create the feedback control signals for the energy controller.
G. A process controller using the spectral information to adjust as necessary the energy applied in the process. The complete system is controlled by the process control unit that handles all of the commands for energy setting, sequencing of the environmental controls and capturing spectral signatures at the output for closed loop process control.
H. An environmental controller provides for inputs and outputs of the process chamber.
(i.e. the inputs: water spray and inert gas, and the outputs: process gases and liquids).

Energy Source

The energy source may be one of the solid-state generators, such as the Model PTS4 generator by Cellencor, Inc. of Ankeny, Iowa. This particular unit includes a computer based controller, power supply, four microwave energy drivers, and a microwave safe process chamber.

The energy source, when programmed for the water hammer is the microwave generator with the pulse of energy needed to have an effective water hammer and having the necessary varying width and repetition rate. The resulting GigaHertz energy packet is supplied to applicators (antennas) via one or more energy driver/modules (power amplifiers). The energy driver/modules have the appropriate connector for waveguide or coaxial cable.

The same energy source or a separate source is programmed to deliver continuous microwave energy at 2.4 to 2.5 GHz when required. The energy driver/modules and the same or different waveguides deliver the microwave energy in the process.

The programmability of the energy source is such that it can accept commands from a laptop computer, desk computer or programmable logic controller (PLC).

Process Chamber

The process chamber has a configuration and size to accommodate a processing container that holds the plant material containing the sought-after organic compound. The process chamber has the work space and is microwave safe with no leakage. The processing container resides in the process chamber and is used for all of the plant processing.

Appropriate safety controls are included in the system. For example interlocks are installed on the door to the process chamber to prevent the door opening while the energy source is operating.

Spectrometer Sampling Stations

Spectrometers read the gas or liquid at the sampling stations located at the output of the process chamber, A spectrograph of the major compounds of interest plus compounds wanted or unwanted is produced and is used to create the feedback signal to the process controller. A control algorithm is applied to produce any required adjustment of the applied energy from the source and to adjust parameters in the process chamber.

Samples are read in a timely manner and the sample tube cleaned with solvent and vacuum dried to maintain high quality readings.

Process Controller

The complete system is controlled in a closed loop by the system process controller, which handles all of the commands for energy settings, sequencing of the environmental controls in the environmental controller and capturing specific spectral peaks from the spectrometer[s] to use in the closed loop process.

Chamber Environment Controller

The chamber environment controller is a microprocessor based (Raspberry Pi) control system and provides control over the following:
Process gases—Nitrogen, Argon, Air
Process pressure—Slight Vacuum, Pressure below atmospheric and up to
2 atmospheres, but always keeping the pressure below the pressure that
would damage the monitoring devices.
Process liquids—Water, with and without additives
Valve operation—gas, pressure, liquid, spectrometer sampling
Chamber Safety—Operator alerts and door opening

Another embodiment of this invention is the breaking open of the plant material by cutting into pieces a whole plant or the selected portions of the plant to expose the inside of the plant material to adjustable levels of microwave energy.

Another major feature of this invention is that the system may be housed in a movable container, such as an ISO container, and carried to the plants in the field where freshly cut plants or selected portions thereof are processed in the processing container of the system in the field.

The above and other features, objects and advantages of this invention will become apparent from a consideration of the foregoing and the following description and the accompanying drawings.

### BRIEF DESCRIPTION OF THE DRAWINGS

FIG. 1 is a block diagram of the system for extracting desired organic compounds. The system employs a variable width and duration microwave pulse and/or continuous microwave energy from a microwave source or sources, or other appropriate sources in accordance with this invention;

FIG. 2 is a block diagram of the system using one or more solid-state generators, such as the Model PTS4 generator by Cellencor. The view shows four microwave output drivers with energy directed toward the processing container, in accordance with this invention;

FIG. 3 is a block diagram of the Model PTS4 generator in a configuration wherein the output of the individual power modules is combined to provide a higher energy output, in accordance with this invention;

FIG. 4 is a block diagram of the process container and process chamber for extracting organic compounds from baled hemp, in accordance with this invention;

FIG. 5 is a top plan view of a processing container held in a processing chamber for safe movement from filling with plant material to inplace for the extraction process.

FIG. 6 is a front elevation view with the fluid of the chamber removed along the dotted line 6-6 in FIG. 5.

### DETAILED DESCRIPTION OF PREFERRED EMBODIMENTS

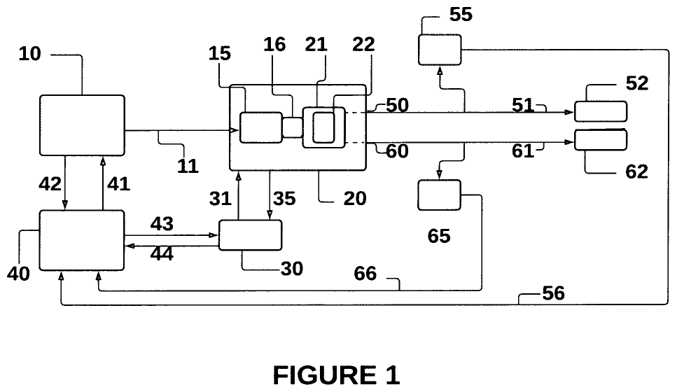

As shown in FIG. 1 the system consists of an energy source 10, a processing chamber 20, a processing container 21 inside the chamber 20, a chamber environment controller 30, a system process controller 40, a first spectrometer 55 for monitoring the gaseous output from output port 50 of the processing container, a collecting unit 52, including a cold trap, for the gaseous output, a second spectrometer 65 for monitoring the liquid output from output port 60 of the processing container 21, a liquid collection unit 62 for the liquid output, including, where necessary, a separator for separating the desired compound as a liquid from water. The system further consists of an applicator or antenna 15 in the processing chamber 20 to propagate the microwave energy 16 from the source 10 to the plant material 22 to be processed in the processing container 21. A transmission line 11, which is either waveguide or coaxial cable, carries the microwaves from the source 10 to the antenna 15.

The complete system is controlled by a system process controller 40, which handles all commands for energy settings, sequencing of the environmental controls in the environmental controller 30 and capturing specific spectral signatures from the spectrometers 55 and 65 for closed loop process control.

The system (FIG. 1) includes the necessary components for a microwave powered system.

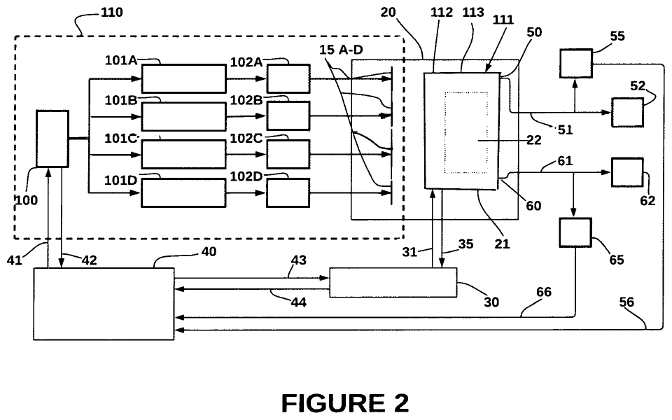

The system shown in FIG. 2 has a solid-state microwave source 110 which may be the Model PTS4 from Cellencor, Inc. This source 110 has four RF exciters 101A,101B,101C and 101D and four microwave drivers 102A, 102B, 102C and 102D, as power amplifiers.

Each power amplifier 102 has an output applied to an antenna or applicator 15. The microwave energy applied to the antenna 15 is propagated as waves 16 (FIG. 1) into the container 21 and plant material 22 for extracting the desired organic compound and or breaking open the plant with the water hammer.

The system includes a laptop computer, desk computer or programmable logic controller (PLC) 100 which receives input information from the system process controller 40 and controls the operation of the solid-state generator 110 to apply pulses for a water hammer to one or more of the antennas 15 or continuous microwaves to one or more of the antennas 15.

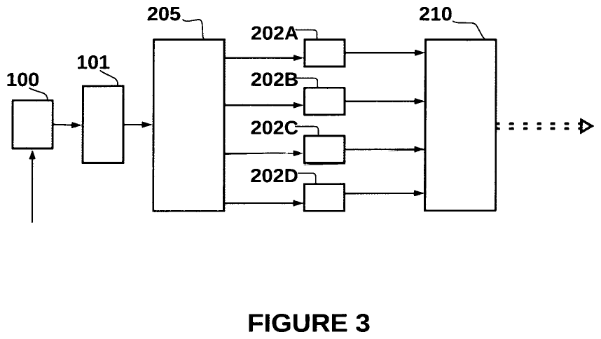

The energy level available at the output of the source 110 may be increased by combining the components of the source as shown in FIG. 3 and proposed by Cellencor. The combination of the four components by Cellencor shown in FIG. 2 may produce an energy level up to 4 KW at the antenna 215 shown in FIG. 3. The source or generator 110 includes an RF exciter 101, a power splitter 205, four microwave drivers 202 and a power combiner 210.

By combining the energy sources 110, the power available at each antenna can be increased. For example, if four of the sources are combined the available power could be 16 KWs from the Cellencor PTS4 sources.

The antennas 15 are positioned in the chamber 20 to most efficiently apply the microwave energy. One position for the antennas is at the same elevation in the chamber and each antenna in a different quadrant around the plant material in the processing container 21 to cover 360 degrees. Additionally, for low power energy sources the antennas may be placed close to the plant material.

Process Chamber

The process chamber 20 is of a size and configuration to accommodate the processing container 21 with the selected plant material 22 in the container.

Processing Container

The processing container 21 has a size and configuration determined by the physical size and condition of the plant material to be processed and the process parameters of the system. The container 21 is made of low loss material, which may be glass or ceramic, for example. For certain plants and configuration of the plant material to be placed in the processing container, the container 21 has a cylindrical shape with a closed bottom with an outlet 60 in or close to the bottom for the flow of liquid from the container.

For example, the plant may be hemp which has been baled in the field to have a cylindrical shape (similar to a bale of hay) with a depth which permits microwave energy at the operating frequency and power level to pass through the bale. For this configuration the container will be cylindrical in cross section.

If other plant material, such as ginger root, is to be processed, the size and shape of the container will hold the root in raw form or after being sliced or chopped in pieces.

As shown in FIG. 2 each container has a port 113 for the introduction of water. The water level in the container is controlled by a valve inside or outside the container (not shown). The water is spread across the plant material in the container by a spray head inside the container (not shown). The plant material is packed loosely in the container so that the water will reach the outside of the plants.

Each container has a port 111 for the input of a process gas, if used. Also, each container has a port 112 for monitoring and adjusting the pressure in the container. Each container has an outlet port 50 for each extracted compound in gaseous form and any water in gaseous form. Port 50 may be in the side of the container or in the top of the container. The container has an outlet port 60, which may be in the side or in the bottom of the container, for the extracted compounds in liquid form and any water or other liquids to be removed from inside the container.

The container has an access, such as a door 121, for insertion of the plant material to be processed. Access may also be provided through a side or the top of the container.

The container 21 has an input or connection for sensing 35 and controlling 31 the environment in the container by environmental controller 30.

The container may have a base that matches the configuration of the container, for example, rectangular or round. A round base is useful when the container is to be rotated and the rectangular base is useful when the container is moved on a conveyor or held in place in a chamber for filling and moving.

Sampling Stations

Spectrometers 55 and 65 (FIGS. 1 and 2) at the sampling stations at the output ports 50 and 60 are able to read a gas or liquid sample through glass or other appropriate tubing 51 and 61. The spectrometers read and analyze the organic compounds of interest plus other organic compounds present from the outputs 50 and 60 and in response to the presence of certain compounds apply feedback signals to the process controller 40.

The spectrometers 55 and 65 are Raman spectrometers and are described in an article entitled “Raman Spectroscopy as a Tool for Process Analytical Technology” published by B&W Tek of Newark, Del. copyright 2017. The spectrometers in the process of this invention are used for real time process control. Additionally the system of this invention is useful in analyzing previously extracted organic compounds and/or the raw material from which selected compounds are to be extracted. As stated in the article the “Raman spectroscopy is a laser-based form of molecular spectroscopy that provides specificity and sensitivity for qualitative and quantitative analyses through their molecular vibrations.” The molecular vibrations of the desired organic compounds in the processed plant material are identified and used to control the parameters of the process. In particular the power level of the applied microwave energy is controlled to avoid damage to the compounds from being overheated.

Other types of spectrometers may be used in place of the laser based Raman spectrometer.

Process Controller

A laptop computer functions as the process controller 40. The algorithm between each spectrometer and the process controller causes the output from the process controller to end the pulsed microwave energy which breaks open the body of the plant material, applies a low energy level continuous microwave and increases this level to cause each desired organic compound to have a phase change for removal from the process chamber.

The laptop computer utilizes standard bus interfaces for communication with all of the individual subsystems. Software is provided to handle the control and data transfers. The algorithm for process sequencing and controlling the individual processes is derived from libraries and system feedback.

The result of the more accurate control of the selective phase change of the selected organic compound is higher purity and less damage.

Chamber Environment Controller

The chamber environmental controller 30 is a microprocessor based (Raspberry Pi) control system and provides control over the following:
Process gases—Nitrogen, Argon, Air.
The use of argon, for example, in place of air reduces the possibility of carbonization of the extracted organic compounds.
Process pressure—Slight Vacuum, Pressure below atmospheric and up to 2 atoms
The pressure is set for different plants to accommodate the vapor pressure of the desired organic compound. The pressure, for example, may advantageously be set below the atmospheric pressure for some organic compounds.
Process liquids—Water, with and without additives.
Water has a surface tension that may interfere with the process when deeper penetration into the fiber of he plant is required. The surface tension is reduced when a surfactant is added to the water in the chamber.

Component size and configuration and operating parameters (FIG. 1) are selected for the particular plant material being processed.

As another nonlimiting example:
Bulbous types of plants require special holding elements in the processing chamber and chambers of a specific size and configuration. One example of this type of plant is ginger root.

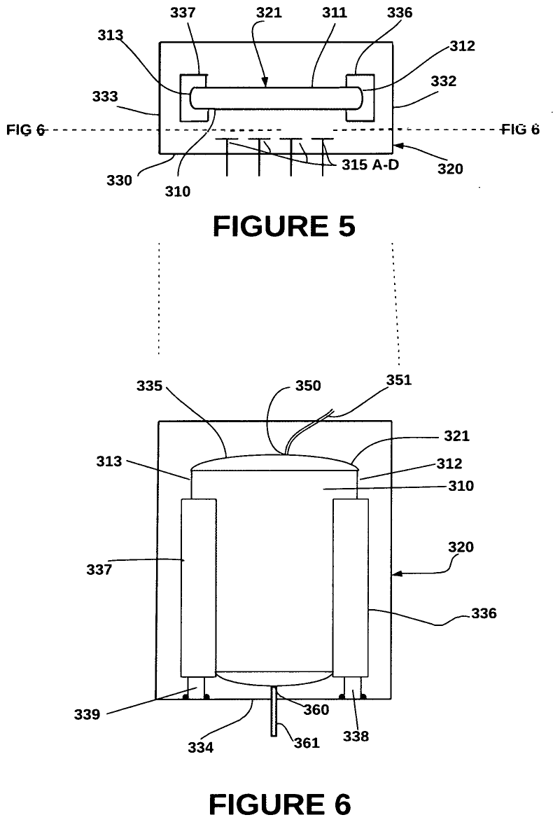

The apparatus and method of the present invention for extracting terpenes, CBGs and CBDs from hemp in various configurations as shown in FIG. 5, includes, but is not limited to a cylindrical bale. An antenna 415 in the center of the bale radiates microwave energy into the bale and changes the phase of the CBGs and the CBDs for removal.

The water content in the hemp may be determined and adjusted in the field after baling or before the hemp is exposed to the microwave energy. If there is insufficient water in the hemp formation, water is added in the container. Also, the hemp may be chopped into small pieces and combined with water to form a slurry to be held in a container and microwave energy is then applied in the slurry to change the phase of the selected compounds in the hemp.

The baled hemp has the vertical center augared out to accommodate the low loss casing 418 and antenna 415. The vertical center will be open if the bale is formed on a removable mandrel in the field. The hemp is held iii an enclosed cylindrical container 20.

The wire or other means for holding the bale in a roll may be cut and panels of hemp cut as the hemp is rolled out. The panels may then be placed in a container for processing.

The apparatus may further include a coupler/rotator 419 between the antenna 415 and transmission line 411 to permit a directional antenna to be rotated in the hemp to apply microwave energy around 360 degrees.

Alternatively, the hemp in a bale may be placed on a table which rotates, as shown in FIG. 5, to provide 360 degree radiation and extraction.

A useful and advantageous system shown in FIGS. 5 and 6, is designed for use in the field or close to the field where the plant is cultivated. This is particularly important when the plant is hemp. Mold often forms in harvested hemp within hours after harvest. Mold may occur as soon as 6 hours. Consequently the ability to process hemp plant material in the field as the hemp is harvested or within a short time after harvest before mold may form is very important. For operation of the system of this invention in the field or close to the field of cultivation, the relative fragile processing container (relative to steel for example) is held in the chamber to protect the container. The container is made of material that causes little loss of microwave energy as the energy wave passes through the walls of the container. Preferrably the walls of the container are made of glass or ceramic material.

A processing container 321 mounted in a processing chamber 320 for a system which can be moved to the field where the plants are cultivated is shown in FIGS. 8 and 9. This is an another embodiment of the invention where the container and chamber are separate from the other components of the system and are moved in and out of the system for filling and for removal of the plant material after processing and for cleaning in preparation for the another filling of plant material. The processing container 321 (FIG. 8) has a rectangular cross-section with rounded ends. The container has a front wall 310 and a rear wall 311 and a rounded right end 312 and a rounded left end 313. The ends may also be planar rather than rounded.

The chamber 320 has a front wall 330, a rear wall 331, a right end wall 332 and a left end wall 333. The walls are joined to form the chamber with a rectangular shape. The chamber 320 has a bottom 334 which closes the chamber at the bottom. The front part of the chamber is removed along the dotted line 350 (line 6-6 shown in FIG. 5) and is shown in FIG. 6.

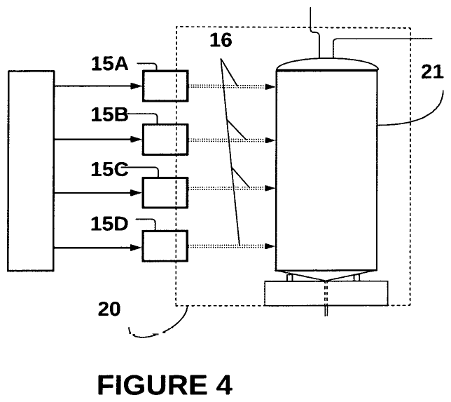

The container 321 and chamber 320 have the ports and opening shown for the container and chamber in FIGS. 2 and 4.

One or more microwave antenna 315 are positioned in the chamber 320 in front of the front wall 310 of the container 320. The walls have a length and height to accommodate the plant material being processed. Further, the distance from the front wall 310 to the back wall 311 is selected with the height and length of the walls to accommodate the plant material and to provide a container wherein the applied microwave energy will pass through the plant material.

To provide uniform heating of the plant material, a number of antenna 315 are placed across the front wall 310 and from top to bottom of the front wall 310. The antenna 315 are held in place by attachment to the inside of the front wall 330 of the chamber 320.

A cover 335 is placed on top of the container to provide an enclosed container.

The container 321 is held in place and supported in the chamber 320 by a right support 336 and a left support 337. The supports 336 and 337 and the container 321 are held above the bottom 334 of the chamber 320 by legs 338 and 339.

### SUMMARY

The process of this invention comprises the steps of

Placing plant material in the process container;

Placing the container in the processing chamber;

Determining the water content in the container;

Adding water and/or having water flow through the container;

Applying pulsed microwave energy to the plant material in the process container at an energy level and frequency to create a water hammer to break open the fiber body of the plant material;

Collecting and transferring the gases released from the plant material upon breaking open the body through an output line wherein the gas compound is observed by a first mass spectrometer and the compound passes to a cold trap gas collector;

Sending a command to the process controller from the first gas spectrometer to reduce the level of energy from the microwave source when the spectrometer senses a selected reduction in the level of gas from the process chamber;

Reducing the energy level and setting the environment in the process chamber for increased energy to liquefy the desired organic compounds which are in solid form;

Collecting and transferring the liquified compounds through an output line for liquids wherein the compounds are observed by a second spectrometer and the liquids pass to a liquid collector;

Generating a command based on the presence of the spectral signature for a selected compound by the second spectrometer to adjust the energy level applied to the plant material to a level to change the phase of the desired compound for removal while avoiding damage which can be caused by excess heat applied to the compound.

While the description above contains specificity, this should not be construed as limiting the scope of the invention; but merely as providing illustrations of the presently preferred embodiment of the invention. Although preferred embodiments and method for extracting subsurface hydrocarbons have been described above, the inventions are not limited to the specific embodiments, but rather the scope of the inventions are to be determined as claimed.

The invention claimed is:

1. The method of extracting a selected organic compound from plant material comprising the steps of placing the plant material in a processing container, adding water to the plant material in the container and applying pulsed microwave energy to the plant material and water at a frequency and energy level to create a water hammer to open the body of the plant material.

2. The method in accordance with claim 1 comprising the further steps of applying continuous wave microwave energy to the plant material to cause a selected organic compound in the plant material to change phase and extracting this compound.

3. The method in accordance with claim 1 comprising the further steps of cutting up the plant material before placing it in the container.

4. The method of claim 1 further comprising the steps of applying continuous wave microwave energy to the plant material while applying the pulsed microwave energy.

5. The method in accordance with claim 1 wherein the frequency of the pulsed microwave energy is 2.4 to 2.5 GHz.

6. The method in accordance with claim 2 wherein the frequency of the continuous microwave energy is 2.4 to 2.5 GHz.

7. A method of extracting organic compounds from plant material comprising the steps of placing the plant material in a container, applying continuous wave microwave energy to the plant material to cause the organic compounds in the plant material to change phase and extracting the compounds.

8. The method of extracting a selected organic compound from plant material comprising the steps of placing the plant material in a processing container, placing the container in a processing chamber, adjusting the water content in the container to a level necessary for the creation of a water hammer, applying pulsed microwave energy to the plant material at an energy level and frequency to create a water hammer to break open the body of the plant material, collecting any gases escaping from the plant material during application of the water hammer, transferring the gases to a cold trap gas collector through a gas line connected to a gas output of the container at a first end and to the cold trap at a second end, observing the spectral signature of the gas flowing through the line by a first spectrometer, determining whether the spectral signature is of a desired organic compound, applying an energy level of continuous wave microwave to the plant material causing the first desired compound to change phase, transferring the compound through a line from the processing container to a collector, observing the spectral signatures of the compound transferred from the container to the collector by a second spectrometer, holding the energy level at the level where the spectral signature of the first desired organic compound is observed by the second spectrometer.

9. The method in accordance with claim 8 comprising the further steps of: generating a control signal from the information in the second spectrometer and using the control signal to control the energy level output from the continuous wave microwave source.

10. The method of extracting organic compounds from plants comprising the steps of: providing the ability to extract individual organic compounds from plant material in a processing container by applying microwave energy to the plant material, monitoring the spectral signature of the compounds at the output of the container and providing a closed feedback loop responsive to the output of the monitoring device to control the energy level of the input microwaves needed to extract the desired compounds.

11. A system for extracting desired organic compounds from plant material comprising a source of microwave energy, a processing container for holding the plant material in the microwave field from the source, the container having an output port for compounds in a gaseous state and an output port for compounds in a liquid state, a processing chamber encasing the container, a first controller of the environment in the chamber, a first spectrometer for monitoring the spectral signature of the compounds in a gaseous state from the gas output from the container, the first spectrometer providing an output signal representative of the spectral signatures of the output gas, a second spectrometer for monitoring the spectral signature of the compounds in a liquid state from the liquid output of the container, the second spectrometer providing an output signal representative of the spectral signatures of the output liquids.

12. The system in accordance with claim 11 further comprising a system process controller for controlling the energy level output from the source in response to the spectral signature of the compounds in a liquid state.

13. The system in accordance with claim 11 further comprising a container for the apparatus for moving the apparatus from one field of plants to another field of plants.
